(19) United States
(12) Patent Application Publication
(10) Pub. No.: US 2007/0118409 A1
(43) Pub. Date: May 24, 2007

(54) Methods and system for processing insurance claims for damaged gemstones

(76) Inventor: Charles Kurt Artinger, Belleville, IL (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/284,638

(22) Filed: Nov. 22, 2005

(51) Int. Cl. G06Q 40/00

(52) U.S. Cl. 705/4

(57) ABSTRACT

A method for processing a claim for a damaged gemstone that is insured is provided. The method comprises receiving from an insured the damaged gemstone, reconditioning the damaged gemstone, inspecting the reconditioned gemstone, and providing a salvage value amount based on the inspection of the reconditioned gemstone.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to insured jewelry, and more particularly to methods and system for processing claims for damaged gemstones.

Items of value are typically insured with insurance companies to offset the cost of replacing the item if an event occurs such that the item needs replacing or is damaged. For example, jewelry is often insured to enable an owner to offset the cost of replacing the jewelry in the event the jewelry is lost, damaged, or stolen. Typically, after such an event occurs, the owner contacts the insurance company and files a claim to have the damaged jewelry replaced. To file the claim, the owner typically files proof of ownership of the jewelry, often using a receipt that shows a purchase date and an amount of purchase of the jewelry.

When jewelry is damaged, depending on the extent of the damage, the gemstone may be reconditioned such that the reconditioned gemstone has a weight that is less than the original weight of the undamaged gemstone. In such instances, generally the insured owner is issued a check to purchase a replacement item or the insurance company issues a check directly to a merchant offering a suitable replacement item for sale. Moreover, to offset their costs, in such instances known insurance companies generally get a salvage estimate from a jeweler as to how much the gemstone will be worth when reconditioned. The insurance company then sells the reconditioned gemstone to a jeweler who then may offer the reconditioned stone commercially.

However, although the insurance companies are able to offset their costs when gemstones are reconditioned, as a result of such a process, insurance companies generally receive less money for the reconditioned gemstones than the gemstone is actually worth. More specifically, with known claim processes, the salvage estimates provided to the insurance companies are generally lower than the value of the reconditioned gemstone because the jeweler provides the estimate without actually knowing the reconditioned gemstone's finished properties, i.e., the cut, the clarity, the color, and/or the carats of the reconditioned gemstone. For example, during reconditioning, the clarity of a gemstone may actually improve because an inclusion was removed along with the damaged portion of the stone, thus improving the gemstone's clarity from a SI1 to a VVS2. Such an improvement in clarity may offset the loss of value of the gemstone as a result of the decreased carat weight. In such an instance, with known claim systems, the jeweler is generally able to resell the reconditioned gemstone at a much higher price than the salvage estimate provided to the insurance company.

### BRIEF SUMMARY OF THE INVENTION

In one aspect, a method for processing a claim for a damaged gemstone that is insured is provided. The method comprises receiving from an insured the damaged gemstone, reconditioning the damaged gemstone, inspecting the reconditioned gemstone, and providing a salvage value estimate to the insurance company based on the inspection of the reconditioned gemstone.

In another aspect, a system for processing an insurance claim for damaged insured jewelry is provided. The system includes a computer system and a server connected to the computer system. The server is configured to receive from a user information based on an initial inspection of the damaged jewelry, receive information regarding the scope of work performed in reconditioning the jewelry, and receive inspection results based on an inspection of the reconditioned jewelry following reconditioning of the jewelry. The server is also configured to compare the inspection results of the reconditioned jewelry to a database populated with current market values for such jewelry, and determine a salvage value amount based on the comparison of the inspection results to the current market value database.

### BRIEF DESCRIPTION OF THE DRAWINGS

FIG. 1 is an exemplary system block diagram for a web-based insurance salvage system;

FIG. 2 is an exemplary expanded version block diagram of a server architecture of a web-based insurance salvage system;

FIG. 3 is a flow diagram of an exemplary web-based method for valuing reconditioned salvage gemstones and that may be utilized with the system shown in FIG. 1;

FIG. 4 is a flow diagram of an exemplary embodiment for determining a salvage value for a damaged gemstone that has been reconditioned and that may be utilized with the system shown in FIG. 1;

FIG. 5 is an exemplary gemstone properties entry page that may be utilized with the system shown in FIG. 1;

FIG. 6 is an exemplary embodiment of a user interface that may be used with the system shown in FIG. 1; and

FIG. 7 is an exemplary embodiment of a second user interface that may be used with the system shown in FIG. 1.

### DETAILED DESCRIPTION OF THE INVENTION

Exemplary embodiments of systems and processes that facilitate processing claims related to insured items that are damaged, are described below in detail. The systems and processes facilitate, for example, determining a salvage value amount for an insured item, such as a gemstone, that had been reconditioned after being damaged and for which an insurance claim has been made. The systems and processes are not limited to the specific embodiments described herein, but rather, components of each system and each process can be practiced independently and separately from other components and processes described herein. Each component and process can also be used in combination with other components and processes.

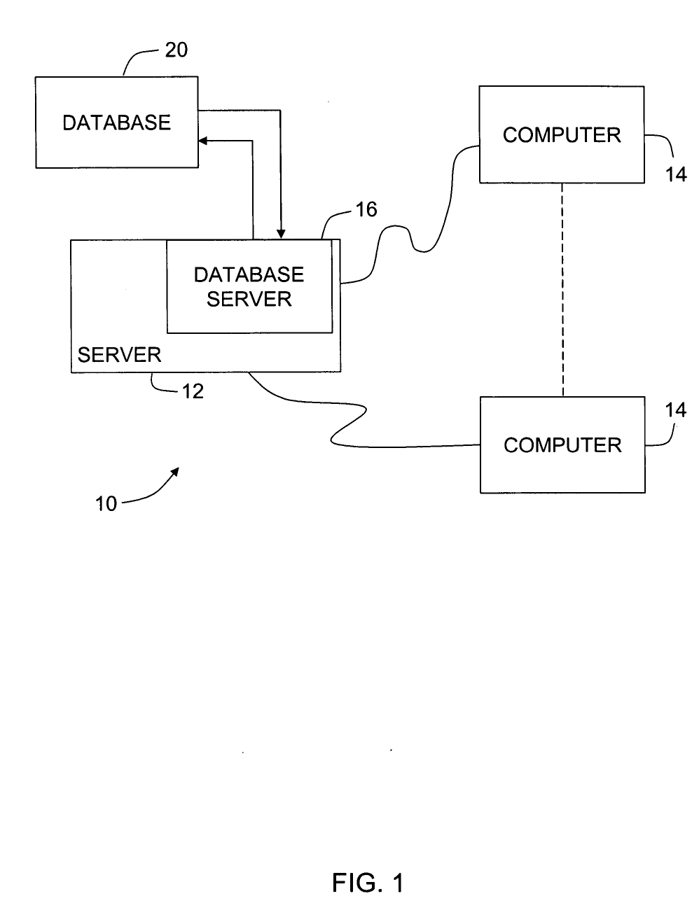

FIG. 1 is an exemplary block diagram of a system 10 that may be used to process a claim for an insured item, such as a gemstone, that has been reconditioned after being damaged. System 10 includes a server sub-system 12, sometimes referred to herein as server 12, and a plurality of user devices 14 connected to server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a web-based phone or other web-based connectable equipment. Server 12 includes a database server 16 connected to a centralized database 20 containing meter information. In one embodiment, centralized database 20 is stored on database server 16 and can be accessed by potential users at one of user devices 14 by logging onto server sub-system 12 through one of user devices 14. In an alternative embodiment centralized database 20 is stored remotely from server 12.

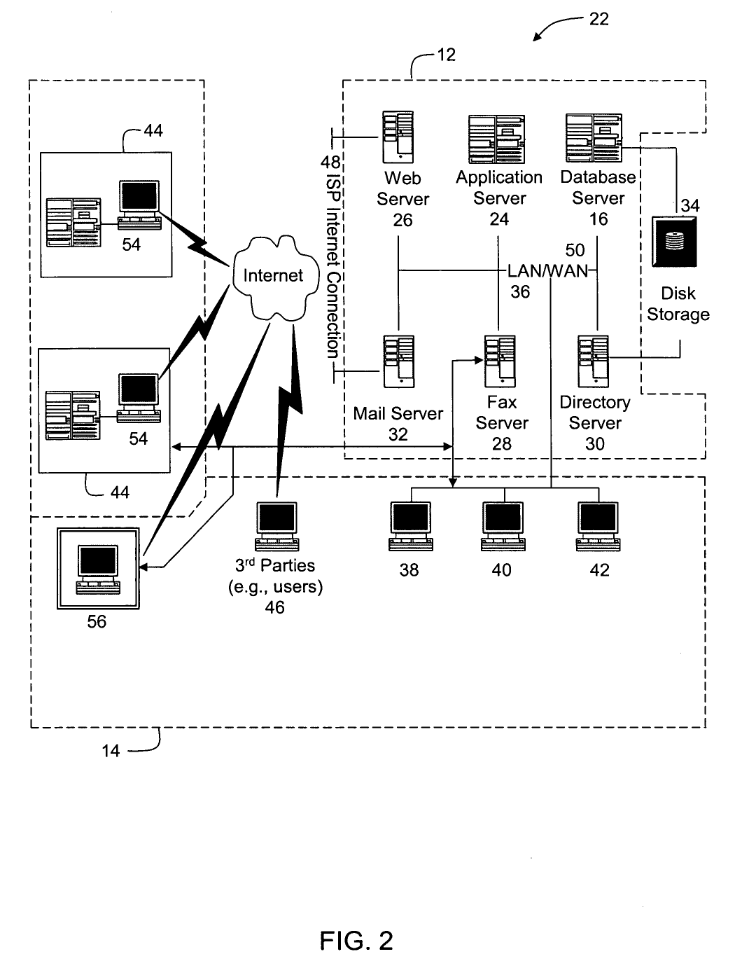

FIG. 2 is an expanded version block diagram of an exemplary embodiment of a server architecture of a system 22 that may be used to process a claim for an insured item, such as a gemstone, that has been reconditioned after being damaged. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator work station 38, a user work station 40, and a supervisor work station 42 are coupled to LAN 36. Alternatively, work stations 38, 40, and 42 are coupled to LAN 36 via an Internet link or are connected through an intranet.

Each work station 38, 40, and 42 is a personal computer having a web browser. Although the functions performed at the work stations typically are illustrated as being performed at respective work stations 38, 40, and 42, such functions can be performed at one of many personal computers coupled to LAN 36. Work stations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to third parties, e.g., users, 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any employee 44 or user 46 having a work station 54 can access server sub-system 12. One of user devices 14 includes a work station 54 located at a remote location. Work stations 54 are personal computers having a web browser. Also, work stations 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other work stations 38, 40, and 42 as well.

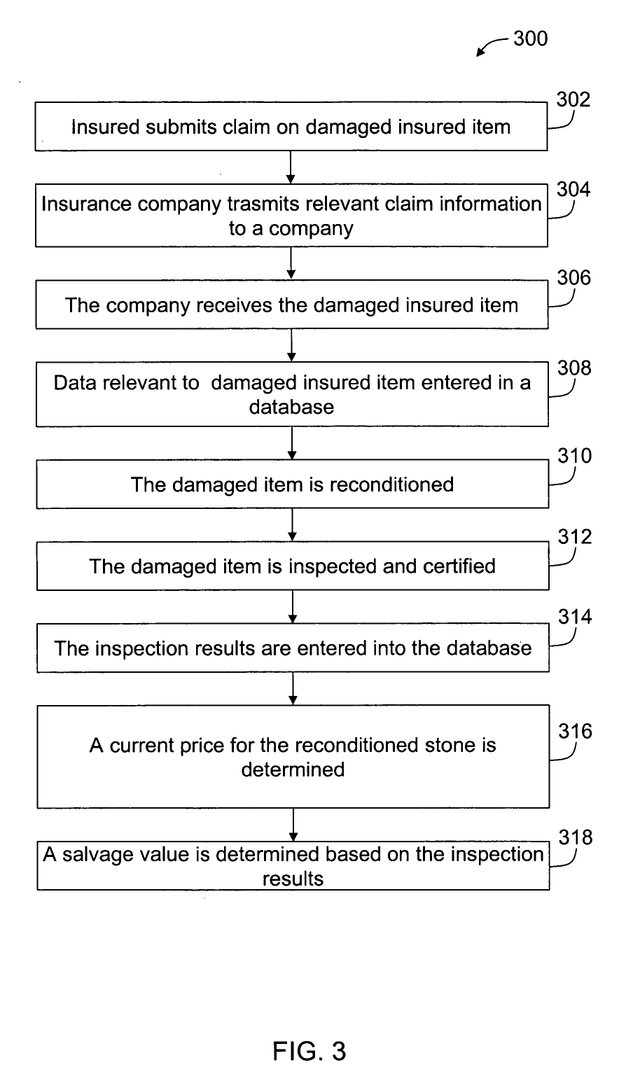

FIG. 3 is a flow diagram for an exemplary web-based method 300 for processing an insurance claim for a damaged gemstone that has been reconditioned. Initially, after a gemstone has become damaged, i.e., the stone has chipped or cracked, the insured submits a claim 302 to their insurance company. Information relevant to the damaged gemstone is transmitted 304 from the insurance company to a company that does business with salvage gemstones (the company) 304. Such information may include, but is not limited to, the claim information, the billing address, and the adjuster information. The salvage company receives 306 the damaged gemstone from the insured either directly from the insured or through the insurance company. The company inspects the gemstone and inputs 308 data relevant to the damaged gemstone into a user device such that the information is stored in a database. The gemstone is then reconditioned 310.

The reconditioned gemstone is then sent to an independent inspector or inspection agency for inspection and certification 312 post reconditioning. In an exemplary embodiment, the reconditioned gemstone is inspected and certified by the Gemological Institute of America (GIA). The reconditioned gemstone is returned to the company with its accompanying inspection certificate, and the inspection results are input 314 into user device and stored in database. To determine a current price for the reconditioned gemstone, the inspection results are compared 316 to a published wholesale pricing guide for gemstones that is accepted and known in the industry. In one embodiment, the inspection results are compared to the Rapaport Diamond Report (Rapaport Report). Deductions based on the properties of the reconditioned gemstone are taken from the current price to determine 318 a salvage value for the reconditioned gemstone. In one embodiment, the company is offered the opportunity to purchase the reconditioned gemstone from the insurance company for the salvage value. In other embodiments, the reconditioned gemstone is offered for sale commercially by other companies.

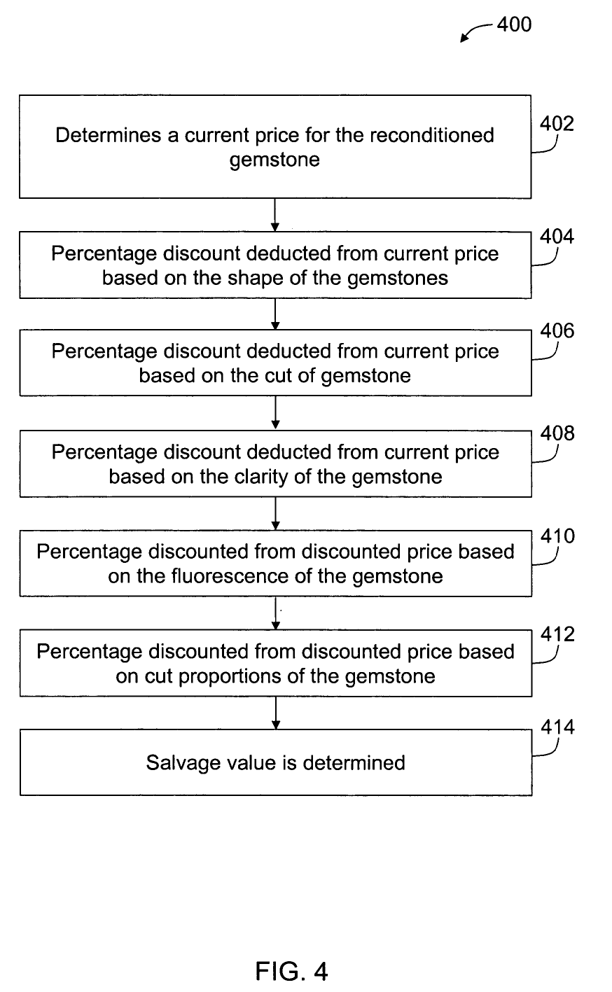

FIG. 4 shows a flow diagram of an exemplary method 400 that may be used with method 300 (shown in FIG. 3) to determine 318 a salvage value for the reconditioned gemstone. Specifically, GIA inspection results for the reconditioned gemstone are compared to the most recent Rapaport Report to determine 402 a current price for the reconditioned stone. A discount percentage based on the current price for the shape of the gemstone is determined 404. For example, for Round and/or Marquise gemstones a 60% discount may be applied, for Pear and/or Oval gemstones the discount percent may be 63%, and for Emerald, Princess, and/or Radiant gemstones the discount percent may be 66%. The determined discount percentage is then applied against or deducted 406 from the current price based on the cut of the gemstone. A discount percentage based on the current price for the clarity of the gemstone is determined 408 and applied against the current price. A discount percentage is deducted 410 from the discounted price based on the fluorescence of the gemstone. A discount percentage is deducted 412 from the discounted price based on the cut proportion of the cut of the gemstone. In an exemplary embodiment, the proportions are determined using the Accredited Gem Appraisers' (AGA) cut rules and charts. After each applicable discount percentage is deducted from the current Rapaport Report price, the salvage value of the gemstone will have been determined 414 based on the actual reconditioned gemstone.

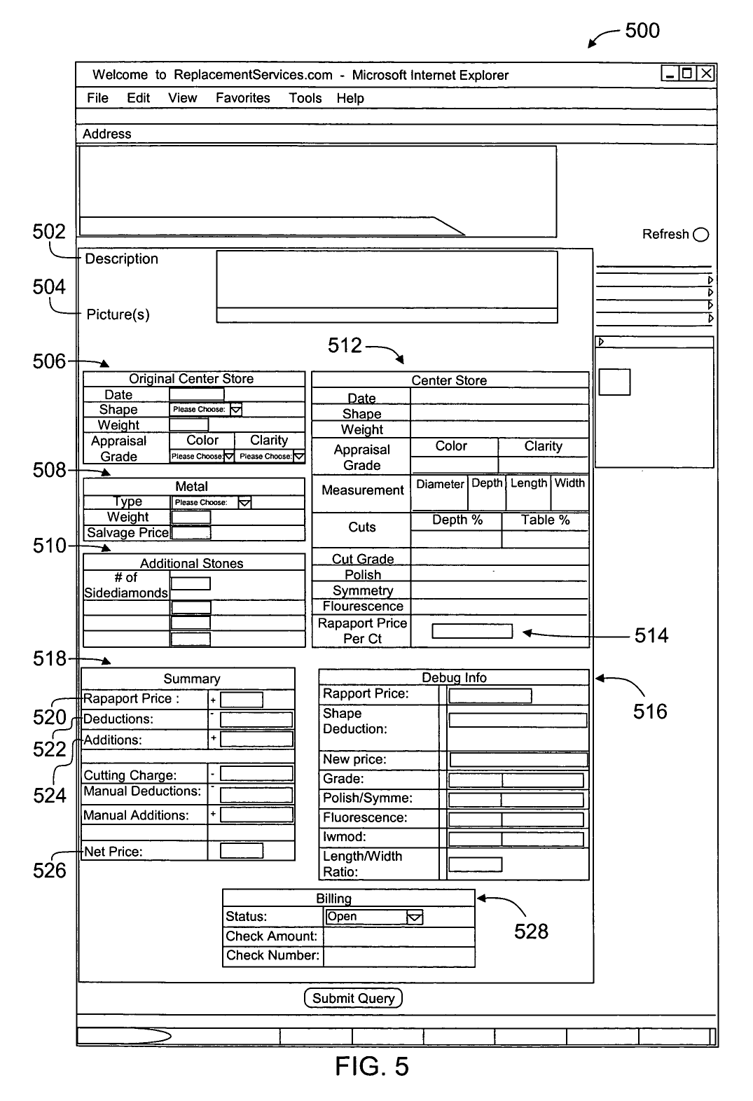

FIG. 5 illustrates an exemplary gemstone properties entry page 500 that may be used with system 10 (shown in FIG. 1). For example, description data field 502 is used to enter a description of the damaged gemstone and a picture data field 504 is provided including a picture of the damaged gemstone to be stored within system 10. Various properties associated with the damaged gemstone are entered in damaged gemstone section 506 such as, but not limited to the original shape, weight, and color of the gemstone. In the exemplary embodiment, section 506 includes a “date” data field, a “gemstone shape” pull-down menu, a “carat weight” data field, a “gemstone color” pull-down menu, and a “gemstone clarity” pull-down menu. If there is jewelry associated with the damaged gemstone, data about the jewelry's materials can be entered in metal section 508. In the exemplary embodiment, section 508 includes a “type” pull-down menu, a “weight” data field, and a “salvage” price data field. If there are additional gemstones attached to the piece of jewelry to which the damaged gemstone is, or was, set in, data relevant to the additional gemstones can be entered in additional gemstone section 510. In the exemplary embodiment, section 510 includes an “entry field” for the number of side diamonds, “data field”, a “weight” data field, a “price per carat” data field, and a “total” data field.

After the stone is reconditioned, the information associated with reconditioned gemstone may be entered in a reconditioned gemstone section 512. In the exemplary embodiment, reconditioned gemstone section 512 includes a “date” data field, a “gemstone shape” pull-down menu, a “carat weight” data field, a “gemstone color” pull-down menu, a “gemstone clarity” pull-down menu, a “diameter” data field, a “depth” data field, a “length” data field, a “width” data field, a “depth” percent data field, a “table percent” data field, a “cut grade” data field, a “polish” pull-down menu, a “symmetry” pull-down menu, a “fluorescence” pull-down menu and a “Rapaport Report price per carat” data field 514.

If further deductions based on the reconditioned gemstone's properties are to be made, entries may be entered in debug information section 516. In the exemplary embodiment, section 516 includes a “Rapaport Report” price data field, a “shape” deduction data field, a “new price” data field, “grade” data fields, “polish/symmetry” data fields, “fluorescence” data fields, an “iwmod” data field, and a “length/width ratio” data field. In the exemplary embodiment, entry page 500 also includes a summary section 518 that includes a “Rapaport Report price” data field 520, a “deductions” data field 522, an “additions” data field 524, a “cutting charge” data field, a “manual deductions” data field, and “manual additions” data field, and a “net price” data field 526. Billing information for the claim is recorded in billing section 528 and the exemplary embodiment, billing section 528 includes a “status” pull-down menu, a “check amount” data field and a “check number” data field.

Values entered in reconditioned gemstone section 506 are compared to a published wholesale pricing guide used as a standard in the industry by the user device 14, and a current price determined from the published wholesale pricing guide for the reconditioned gemstone is displayed in data field 514. The salvage value is determined based on the values entered in summary section 518. For example, deductions data field 522 contains the determinations of discounts applicable to the reconditioned gemstone, and additions from values are populated in an additions data field 524. Moreover, the cutting charge, manual deductions, and manual additions are also populated in summary section 518, the salvage value is calculated by the user device 14 by subtracting deductions data 522. The determined salvage value of the reconditioned gemstone is displayed in net price data field 526.

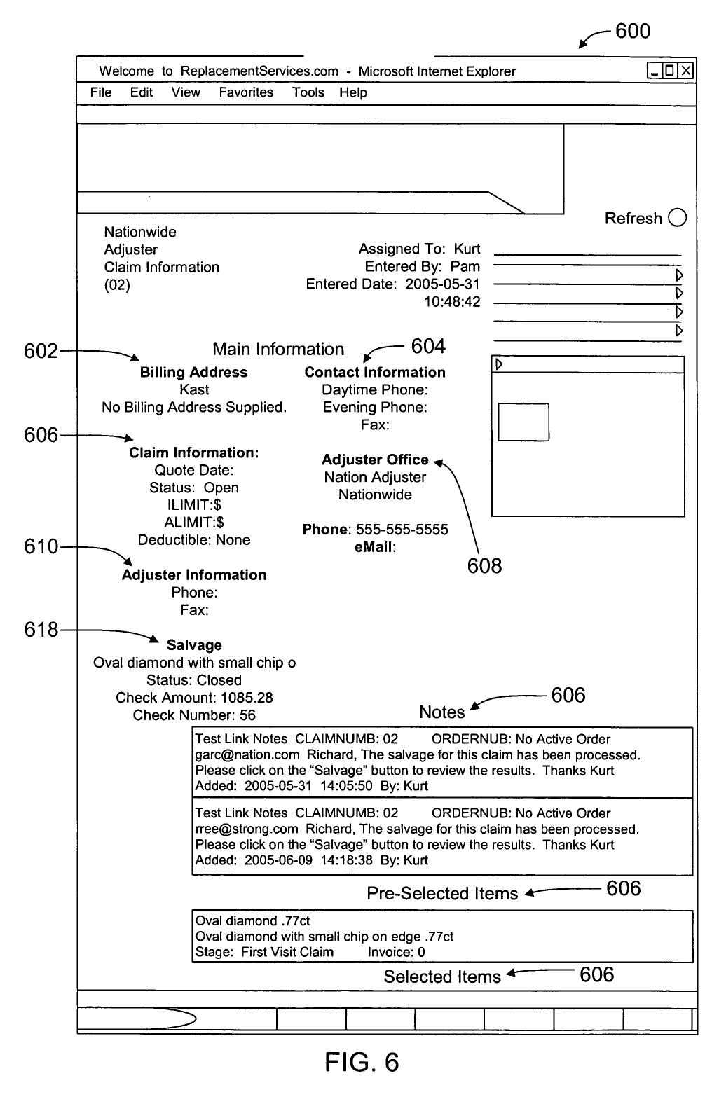

FIG. 6 illustrates a screen shot of an exemplary user interface 600 that may be used with system 10 (shown in FIG. 1). Information about the insured is displayed in Billing Address Section 602 and Contact Information Section 604. Insurance claim information is displayed in Claim Information Section 606 and information relevant to the insurance adjuster is displayed in Adjuster Office Section 608 and Adjuster Information Section 610.

Interface 600 also includes a Pre-Selected Items Aea 614 and Selected Items Aea 616 that display information relevant to a suitable replacement gemstone for the damaged gemstone that is the subject of the insurance claim. To access information relevant to the damaged gemstone, the user may select the “Salvage” link 618. By selecting the “Salvage” link 618, the user is taken to an interface screen which displays information about the damaged gemstone and the reconditioned gemstone, as is described in more detail below.

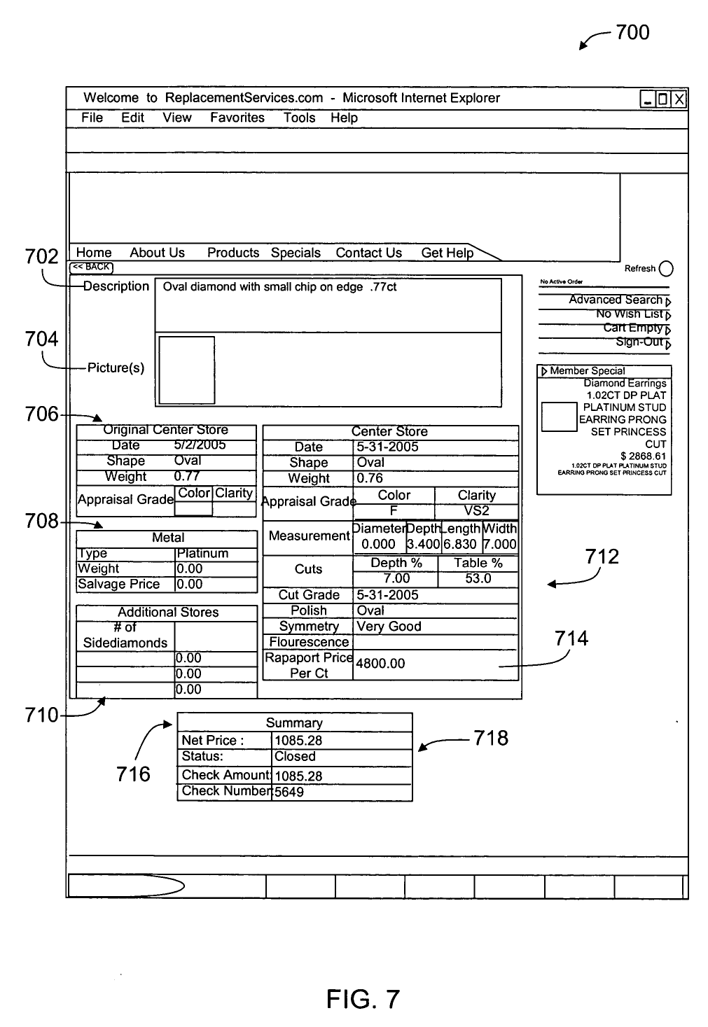

FIG. 7 illustrates a screen shot of an exemplary embodiment of a user interface or salvage data screen 700 that may be used with system 10 (shown in FIG. 1). Screen 700 displays data entered in gemstone properties entry page 500. By accessing salvage information screen 700, a description of the damaged gemstone 702 and picture of the damaged gemstone 704 are displayed. A damaged gemstone data entry field 706 displays data entered relevant to the damaged gemstone. If information was entered relevant to the associated jewerly, the information is displayed in Metal box 708. If additional gemstone data was entered, the information is displayed in Additional Stones box 710. Data input into reconditioned gemstone section 512 is displayed in reconditioned gemstone box 712.

Reconditioned gemstone box 712 includes a current price box 714 that displays the current price determined in Rapaport Report price per carat data field 514. A Summary box 716 displays salvage value 718 as determined in net price data field 526. The data entered in billing section 528 is also displayed in Summary box 716.

The above-described methods and systems for processing claims are cost-effective and highly reliable. The methods and systems enable insurance companies to recover additional funding while reducing insurance losses than is generally available using known systems and methods. Specifically, because the salvage value is determined and is only transmitted to the insurance company after the insured item is reconditioned, the insurance company receives a salvage value that is reflective of the actual value of the reconditioned item, rather than an estimated value provided based on the damaged item. As a result, the methods and systems described herein facilitate processing insurance claims for damaged items, and more particularly damaged jewelry including gemstones, in a cost-effective and reliable manner.

Exemplary embodiments of insurance claim processing systems are described above in detail. The methods are not limited to the specific embodiments described herein, but rather, aspects of each processing system may be utilized independently and separately from other insurance claim systems and processes described herein. For example, the method of determining a salvage value can also be used in combination with other insurance claim processes and items other than just jewelry or gemstones.

While the invention has been described in terms of various specific embodiments, those skilled in the art will recognize that the invention can be practiced with modification within the spirit and scope of the claims.

What is claimed is:

1. A method for processing an insurance claim for a damaged gemstone, said method comprises:
receiving from an insured the damaged gemstone;
reconditioning the damaged gemstone;
inspecting the reconditioned gemstone; and
providing a salvage value estimate to the insurance company based on the inspection of the reconditioned gemstone.

2. A method according to claim 1 wherein said step of providing a salvage value estimate comprises the steps of:
comparing the inspection results of the reconditioned gemstone with a published wholesale pricing guide to determine a current price for the reconditioned gemstone; and
determining the salvage value amount based on the current price.

3. A method in accordance with claim 2 wherein said step of comparing the inspection results of the reconditioned gemstone comprises the step of accessing a database to determine the current price for the reconditioned gemstone.

4. A method in accordance with claim 2 wherein said step of comparing the inspection results of the reconditioned gemstone comprises the step of accessing the current price for the reconditioned gemstone via a computer-based network.

5. A method in accordance with claim 2 wherein said step of comparing the inspection results of the reconditioned gemstone information comprises the step of accessing the current price for the reconditioned gemstone from the published wholesale pricing guide via the Internet.

6. A method in accordance with claim 1 wherein inspecting the reconditioned gemstone further comprises determining a total carat weight for the reconditioned gemstone.

7. A method in accordance with claim 1 wherein inspecting the reconditioned gemstone further comprises determining a gemstone color of the reconditioned gemstone.

8. A method in accordance with claim 1 wherein inspecting the reconditioned gemstone further comprises determining a gemstone clarity for the reconditioned gemstone.

9. A system for processing an insurance claim for jewelry that is damaged, said system comprising:
a computer system; and
a server connected to said computer system, said server configured to:
receive from a user information based on an initial inspection of the damaged jewelry;
receive information regarding a scope of work performed in reconditioning the jewelry;
receive inspection results based on an inspection of the jewelry after the jewelry has been reconditioned; and
determine a salvage value amount based on the the inspection results of the jewerly.

10. A system in accordance with claim 9 wherein to receive information regarding a scope of work performed in reconditioning the jewelry said server is further configured to receive information related to the extent of damage of the jewelry.

11. A system in accordance with claim 9 wherein to receive inspection results based on an inspection of the reconditioned jewelry said server is further configured to receive information relevant to a reconditioned gemstone included within the jewelry.

12. A system in accordance with claim 11 wherein to receive inspection results based on an inspection of the reconditioned jewelry said server is further configured to receive information indicative of a total carat weight of the reconditioned gemstone.

13. A system in accordance with claim 11 wherein to receive inspection results based on an inspection of the reconditioned jewelry said server is further configured to receive information indicative of a gemstone color for the reconditioned gemstone.

14. A system in accordance with claim 11 wherein to receive inspection results based on an inspection of the reconditioned jewelry said server further configured to receive information indicative of a gemstone clarity for the reconditioned gemstone.

15. A system in accordance with claim 11 wherein said server is further configured to calculate a settlement amount based on the calculated salvage amount.

16. A system according to claim 11 wherein said server is further configured to:
receive login information from the user; and
determine a functionality available to the user and the information the user can view based on a user level permission provided the user.
